(19) United States
(12) Patent Application Publication
(10) Pub. No.: US 2010/0039566 A1
(43) Pub. Date: Feb. 18, 2010

(54) DISPLAY SYSTEM AND METHOD FOR SWITCHING DISPLAY MODE

(75) Inventors: Hyun-Seok Kim, Gumi-City (KR); Bong-Soon Lee, Gumi-City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/513,871

(22) PCT Filed: Nov. 2, 2007
(86) PCT No.: PCT/KR2007/005506

§ 371 Date: May 22, 2009

(30) Foreign Application Priority Data
Nov. 8, 2006 (KR) 10-2006-0109812

(51) Int. Cl. H04N 5/268

(52) U.S. Cl. 348/705; 348/E05.057

(57) ABSTRACT

Provided are a display system and a method for switching a display mode. Display modes according to kinds of programs are set up and stored. When detecting program activation by a user s request, an image of the program activated in the preset display mode is displayed after confirming a preset display mode in the program.

### TECHNICAL FIELD

The present disclosure relates to a display system, and more particularly, to a display system and a method for automatically switching a display mode according to kinds of activated programs.

### BACKGROUND ART

A display system typically includes various components that vary values of inputted red(R), green(G), and blue(B) image signals.

For example, there are preamp offset/gain, scaler bright/contrast, gamma, etc., and when changing their values, a brightness signal and a color signal are simultaneously varied.

Accordingly, provided is a mode switching function in which R, G, and B signals are converted into YUV signals to separately operate the brightness signal Y and the color signal UV, and theses signals Y and UV can be accessed through a specific table.

That is, there are an adaptive color enhancer (ACE) adjusting the brightness signal Y, and a real color management (RCM) adjusting a Luma Curve based on an analyzed result of an inputted histogram. Based on this, a dark screen is adjusted to be darker, and a bright screen is adjusted to be brighter.

Additionally, the RCM adjusts the color signal UV to emphasize a specific color more through adjusting hue and saturation.

For example, a user can select a preferred mode according to programs executed by the user. That is, a game mode is selected if the user wants to play a game, and a movie mode is selected if the user wants to watch a movie.

Additionally, a general mode switching can be set by using an executing program or a display data channel command interface (DDC-Ci) program according to a screen, or directly using an on-screen-display (OSD) key through a user.

A related display system mode switching apparatus includes a key input unit, an external interface unit, a controller, and a scaler. The key input unit receives required commands from a user and a computer and then determines a preset mode that a user wants to change in order to deliver a preset mode switching signal through DDC-Ci communication according to commands inputted through a keyboard or a mouse. The external interface unit receives a preset mode switching signal inputted from the computer and an image signal. The controller receives the mode switching signal inputted through the key input unit or the external interface unit to adjust the inputted image signal based on a corresponding mode. The scaler adjusts an image signal inputted according to the control signal of the controller.

In mode switching operations of the related art display device, a user inputs a preset mode switching signal through a mouse or a keyboard, and then the computer receives a command according the signal. Then, the display device determines a mode that a user wants to change, and delivers the determined preset mode and coordinates information to the controller through the external interface unit.

Then, the controller adjusts the inputted image based on the preset mode inputted through the external interface unit, and adjusts the inputted image according to the inputted command when a preset mode switching command is inputted through the key input unit. The scaler adjusts the inputted image signal according to a control signal of the controller.

### DISCLOSURE OF INVENTION

### Technical Problem

However, according to a mode switching device of the related art display device, a user manually sets each preset mode using an OSD or a DDC-Ci program according to executing programs or a screen, and also resets the preset mode while switching to another program.

That is, the controller in the display device can switch a preset mode by only an input of a setting switch signal through a user.

### Technical Solution

Embodiments provide a system and a method for easily switching a display mode according to types of programs.

Embodiments also provide a system and a method for providing the optimized display mode according to a display area of activated programs.

The details of one or more embodiments are set forth in the accompanying drawings and the description below. Other features will be apparent from the description and drawings, and from the claims.

### Advantageous Effects

Display modes according to kinds of programs are set up and stored. When detecting program activation by a user s request, an image of the program activated in the preset display mode is displayed after confirming a preset display mode in the program.

### BRIEF DESCRIPTION OF THE DRAWINGS

FIG. 1 is a block diagram of a display system according to an embodiment.

FIG. 2 is a flowchart of a method for switching a display mode according to one embodiment.

FIG. 3 is an exemplary view illustrating a screen displayed when switching a display mode according to one embodiment.

FIG. 4 is a flowchart of a method for switching a display mode according to one embodiment.

FIG. 5 is a flowchart of a method for switching a display mode according to another embodiment.

FIG. 6 is an exemplary view illustrating a screen displayed when an exemplary view illustrating a screen displayed when switching a display mode according to another embodiment.

FIG. 7 is a flowchart of a method for switching a display mode according to another embodiment.

FIG. 8 is a flowchart of a method for switching a display mode according to further another embodiment.

FIG. 9 is an exemplary view illustrating a screen displayed when an exemplary view illustrating a screen displayed when switching a display mode according to further another embodiment.

### MODE FOR THE INVENTION

Reference will now be made in detail to the embodiments of the present disclosure, examples of which are illustrated in the accompanying drawings.

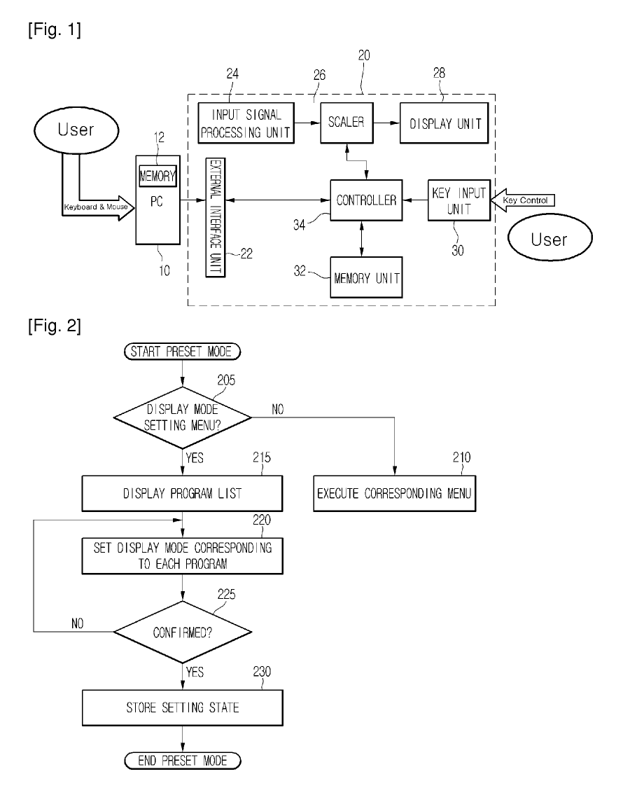

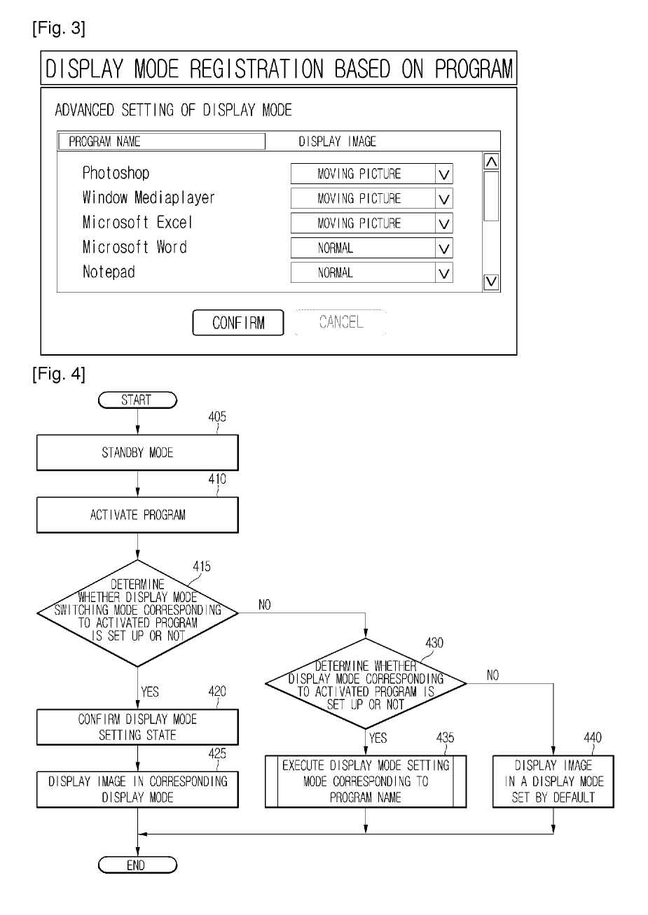

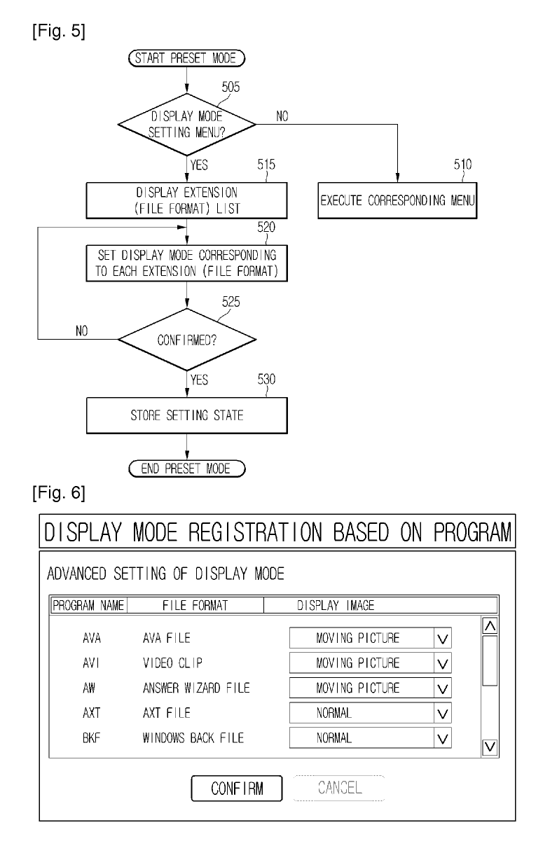

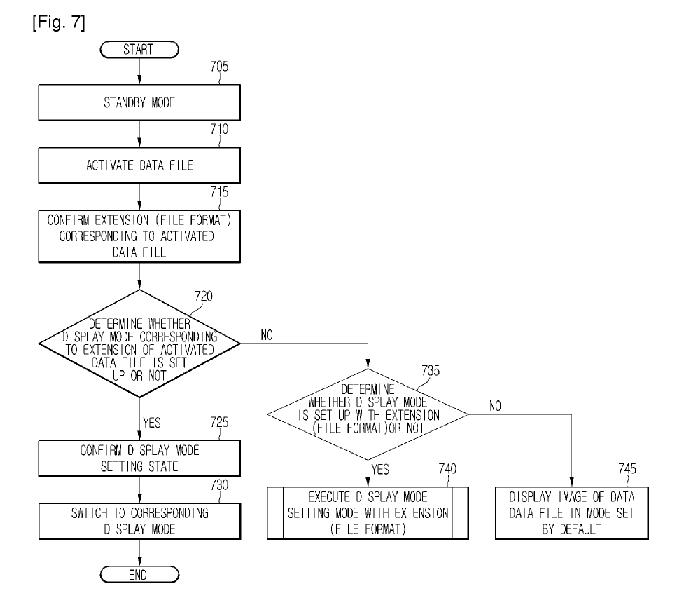

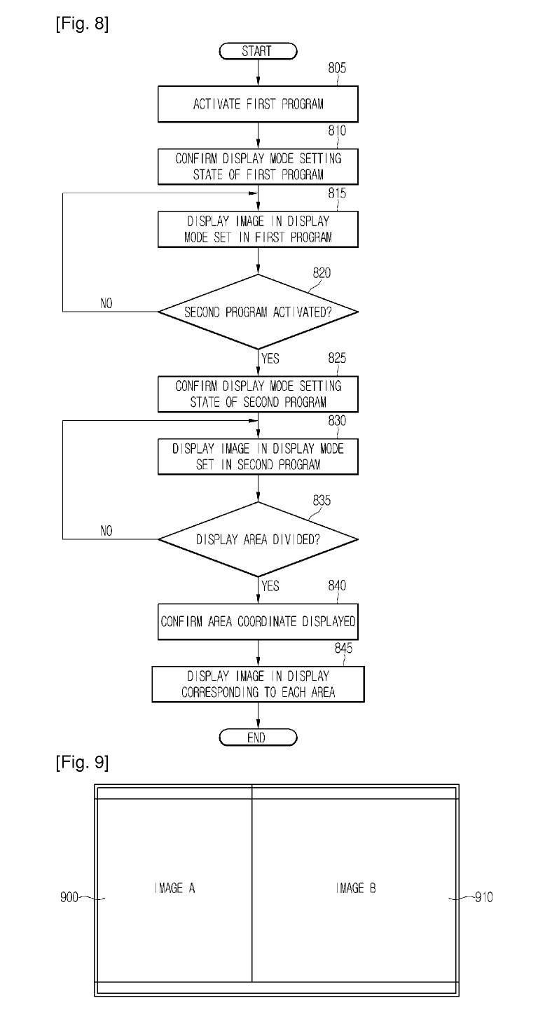

FIG. 1 is a block diagram of a display system according to an embodiment. FIG. 2 is a flowchart of a method for switching a display mode according to one embodiment. FIG. 3 is an exemplary view illustrating a screen displayed when an exemplary view illustrating a screen displayed when switching a display mode according to one embodiment. FIG. 4 is a flowchart of a method for switching a display mode according to one embodiment. FIG. 5 is a flowchart of a method for switching a display mode according to another embodiment. FIG. 6 is an exemplary view illustrating a screen displayed when an exemplary view illustrating a screen displayed when switching a display mode according to another embodiment. FIG. 7 is a flowchart of a method for switching a display mode according to another embodiment. FIG. 8 is a flowchart of a method for switching a display mode according to further another embodiment. FIG. 9 is an exemplary view illustrating a screen displayed when an exemplary view illustrating a screen displayed when switching a display mode according to further another embodiment.

As illustrated in FIG. 1, a display system with a display mode switching function according to an embodiment includes a computer 10 and a display device 20. The computer 10 determines whether there is an activated program or not, executes display mode switching set according to kinds of activated programs, and switches a display mode of coordinate s information for an area where an image corresponding to the activated program is displayed. The display device 20 is connected to the computer 10 and displays an image in a preset display mode corresponding to the activated program.

The display device 20 displays an image about the activated program in the preset display mode through communication with the computer 10, or displays the image in the preset display mode according to the determination of a controller 34 when an image stored in a memory unit 32 of the display device 20 is activated by a user without connection to an external device such as the computer 10.

Additionally, the display device 20 includes an external interface unit 22, an input signal processing unit 24, a scaler 26, and a display unit 28. The external interface unit 22 receives display mode switching and image signals from the computer 10 through a communication line. The input signal processing unit 24 receives the image signal from the external interface unit 22 for signal processing. The scaler 26 displays the image signal in the preset display mode. The display unit 28 displays the image signal processed through the scaler 26.

According to the embodiment, when program stored in the memory unit 12 of the computer 10 is activated in the display device 20 connected to the computer 10, the display device 20 detects the activated program to display the image in the corresponding display mode. This will be described as follows.

An embodiment of a display system with a display mode switching mode will be described in more detail with reference to FIGS. 2 to 8.

FIG. 2 is a flowchart of a method for switching a display mode according to one embodiment. FIG. 3 is an exemplary view illustrating a screen displayed when an exemplary view illustrating a screen displayed when switching a display mode according to one embodiment. Referring to FIGS. 2 and 3, the display device 20 requests execution of a preset mode that can set various functions through a local key and a remote controller. Accordingly, the display device 20 executes the preset mode according to the request and displays a list for functions that can be set in advance by a user.

In operation 205, the controller 34 determines whether a request for executing a display mode setting menu that set a display mode corresponding to a program activated by a user is received or not. In operation 210, the controller 34 executes the selected corresponding menu if the request for setting the display mode is not received.

On the other hand, as illustrated in FIG. 3, a program list executable in the computer 10 is displayed if the request for setting menu is received for execution in operation 215. The controller 34 receives a display mode corresponding to each displayed program in operation 220. That is, as illustrated in FIG. 3, an image is displayed in a corresponding display mode when detecting an arbitrary program in the controller 34 of the display device 20.

For example, this is for setting in which the moving picture is displayed in an optimized state with an appropriate brightness and colors in a case of setting a display mode of an image as a moving picture when a Photoshop program is activated.

As described above, the controller 34 determines whether a display mode setting corresponding to each program is completed or not in operation 225, and then stores a display mode setting state set by a user in the memory unit 32 if the display mode setting is completed in operation 430.

In a case where a program is activated in the display device 20 according to the display mode setting of one embodiment, image display operations will be described in more detail with reference to FIG. 4.

The controller 34 displays an arbitrary image or operates a standby mode that waits an input signal of a user when power is turned on in operation 405. The controller 34 detects that an arbitrary program is activated by a user s request in operation 410, and determines whether a preset display mode is in the activated program or not in operation 415.

The controller 34 confirms a name of the activated program according to the determination result, and also confirms a setting state of a preset display mode when the preset display mode is in the activated program in operation 420. Thereafter, the controller 34 displays an image corresponding to the activated program according to the setting state of the confirmed display mode in operation 425.

On the other hand, the controller 34 determines whether a display mode corresponding to the activated program is set up or not if the preset display mode for the activated program is not set up in operation 430. In operation 435, the controller 34 operates a setting mode that set the display mode with the program name as illustrated in FIG. 2 when a display mode corresponding to the activated program is set up by a user. In operation 440, when the display mode corresponding to the activated program is not set up or an additional setting mode is not executed, a corresponding image is displayed in a general display mode (e.g., preset brightness, colors, etc.).

As described above, the display mode switching operation according to the one embodiment confirms the name of the activated program or a program that executes data to determine whether the display mode corresponding to the preset program is set up or not when a user selects to activate an arbitrary program or data stored in the computer or the display device. Accordingly, the image corresponding to the confirmed program is displayed in the preset display mode.

FIGS. 5 and 6 are a view of a method for switching a display mode and an exemplary view illustrating a screen displayed when switching a display mode, respectively, according to another embodiment. Referring to FIGS. 5 and 6, the method for switching a display mode according to another embodiment is identical to that of the one embodiment.

That is, as illustrated in FIG. 6, the controller 34 displays an extension (a file name) list of data that can be executable in the computer 10 or the display device 20 in operation 515 when the display mode setting menu is executed by a user in operation 505. Then, the controller 34 sets up the display mode according to the displayed extension name in operation 520. The controller 34 determines whether setting of a display mode by a user is completed or not in operation 525, and stores the setting state in the memory unit in operation 530.

FIG. 7 is a flowchart of a method for switching a display mode according to another embodiment. Referring to FIG. 7, the controller 34 displays an arbitrary image when the power is on, or operates in a standby mode waiting an input signal of a user in operation 705. The controller 34 detects activation of an arbitrary data file caused by a user s request in operation 710, and determines whether a preset display mode is in the activated data file or not in operation 715.

The controller 34 confirms an extension (a file format) of the activated data file according to the determination result, and confirms a setting state of the preset display mode in operation 720. Thereafter, the controller 34 displays an image corresponding to the activated data file according to the setting state of the confirmed display mode in operation 725.

On the other hand, the controller 34 determines whether the display mode corresponding to the activated data file will be set up or not when the preset display mode about the activated data file is not set up in operation 735. In operation 735, the controller 34 operates a setting mode that sets a display mode with an extension (a file format) name of a data file as illustrated in FIG. 5 when the preset display mode about the activated data file is set up by a user. In operation 740, the controller 34 displays a corresponding image in a general display mode (e.g., brightness, colors, etc. set by default) when the display mode about the activated program is not set up by a user, or an additional setting mode is not executed.

As described above, the display mode switching operations according to another embodiment confirms an extension (a file format) of the activated data file and displays a corresponding image in the preset display mode when an arbitrary data file stored in the computer or the display device is selected by a user for activation.

FIG. 8 is a flowchart of a method for switching a display mode according to further another embodiment. FIG. 9 is an exemplary view illustrating a screen displayed when switching a display mode according to further another embodiment. Referring to FIGS. 8 and 9, the controller 34 activates a corresponding program (a first program) in operation 805 when receiving a command for a predetermined program operation through a user during a standby mode or an arbitrary operation mode. The controller 34 confirms a setting state of a display mode preset by a user according to the activated program in operation 810. The controller 34 displays an image of the activated first program in the confirmed display mode in operation 815.

The controller 34 determines whether an activation command signal of another second program is inputted or not when displaying an image corresponding to the first program in operation 820. Thereafter, the controller 34 confirms the setting state of the preset display mode of the second program with the activation requiring command in operation 825. The controller 34 displays an image of the activated second program according to the setting state of the confirmed display mode in operation 830.

When displaying the image for the second program, the image of the first program in display becomes deactivated or minimized.

That is, when the image of the second program is activated to be displayed and the image of the first program is deactivated, the controller 34 determines whether a request signal that simultaneously activates the images of the first and second programs is inputted or not in operation 835. When the request signal is inputted, the controller 34 confirms coordinates of an area where the images of the first and second programs are simultaneously displayed.

The controller 34 displays the images of the first and second programs in the display mode corresponding to the display area. That is, as illustrated in FIG. 9, the display device 20 includes an image display area 900 of the first program and an image display area 910 of the second program, separately. Accordingly, the controller 34 displays the divided displayed images in a display mode preset in the first and second programs.

As described above, the display mode switching according to the further another embodiment makes it possible to change into a corresponding display mode for displaying when a plurality of programs or data files are activated. At this point, when changing the first display mode into the second display mode for displaying the image, brightness of a screen changes gradually or incrementally by an arbitrary time.

Additionally, when the signal for simultaneously displaying the images of the first and second programs is inputted, a value of the coordinates about an area where the respective images are displayed is calculated to display the first and second images in a display mode according to a corresponding area.

Any reference in this specification to “one embodiment,” “an embodiment,” “exemplary embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An image display system with a mode switching function, the system comprising:
a computer storing a display mode according to a program to be activated, changing an image according to the program into a preset display mode to display the image when the program is activated; and
a display device displaying an image in a preset display mode corresponding to a predetermined program when the predetermined program is activated according to a control signal of the computer.

2. The system according to claim 1, wherein the computer delivers a corresponding command through the display device and a display data channel command interface (DDC-Ci) communication.

3. The system according to claim 1, wherein the computer comprises:
a key input unit receiving a request command from a user;
a memory unit storing a program and data according to the program, and setting a display mode according to kinds of the programs;
an external interface unit connected to one of an audio device, a display device, and a communication line; and
a controller reading a program stored in the memory unit according to an activation request signal of the program for an output in an external device connected through the external interface unit, and displaying an image in a preset display mode corresponding to the program.

4. The system according to claim 1, wherein the computer displays an image in a display mode of a program activated according to one of a program name and an extension name.

5. The system according to claim 1, wherein when detecting an activation request signal for a plurality of programs, the computer extracts coordinates of an area where the plurality of programs are displayed, and displays an image in a preset display mode corresponding to a program displayed in each area.

6. A method for controlling an image display system with a display mode switching function, the method comprising:
setting and storing a display mode according to kinds of programs;
confirming a preset display mode in a program when detecting activation of the program by a user s request; and
displaying an image of the activated program in the preset display mode.

7. The method according to claim 6, wherein the setting of the display mode comprises setting the display mode according to one of a program name and an extension name of data.

8. The method according to claim 6, further comprising:
outputting a message notifying whether a display mode corresponding to the activated program is set up or not when there is no preset display mode in the activated program; and
setting a display mode of a program in which the activated display mode is not set up according to setting of a user.

9. The method according to claim 6, further comprising confirming a display mode corresponding to each program to display an image in a corresponding display mode when activating a plurality of programs.

10. The method according to claim 9, further comprising:
confirming an area where an image corresponding to each program is displayed in a case where a plurality of programs are activated and divided in one screen to simultaneously display images; and
displaying an image in a preset display mode of the programs according to each of the areas.

11. The method according to claim 6, further comprising:
confirming a preset display mode in a first program and a second program in a case where the second program is activated after the first program is activated; and
outputting an on-screen-display (OSD) that notifies display mode switching in a case where preset display modes in the first and second programs are different.

12. An image display system with a display mode switching function, the system comprising:
a memory unit storing a program and data according to the program, and setting a display mode according to the program;
a controller activating the program according to an activation request of the program stored in the memory unit by a user s request, and confirming a preset display mode in the program to display an image of the program in a corresponding display mode;
a display unit displaying an image corresponding to the activated program in a preset display mode according to a control signal of the controller; and
